(19) United States
(12) Patent Application Publication
(10) Pub. No.: US 2011/0191406 A1
(43) Pub. Date: Aug. 4, 2011

(54) Commenting method and system

(76) Inventors: Thomas Plunkett, Brooklyn, NY (US); Nicholas Guido Denton, New York, NY (US)

(21) Appl. No.: 12/853,251

(22) Filed: Aug. 9, 2010

Related U.S. Application Data
(60) Provisional application No. 61/232,306, filed on Aug. 7, 2009.

(51) Int. Cl. G06F 15/16

(52) U.S. Cl. 709/203

(57) ABSTRACT

A commenting method and system publishes comments related to an online article. Comments are received from and published to internet connected electronic devices. Comments received from starred commenters are stored in a tier 1 database and published by default. Comments received from a commenter without a star are stored in a tier 2 database. Comments in the tier 2 database are only published if they are approved by a starred commenter. If a tier 1 comment is in reply to another comment, all antecedent comments to the reply are also published, even if the antecedents are in tier 2. Comments may originate from individual readers. Comments may also be received by parsing an external feed from a website to extract each comment and commenter. These comments are published with the individual-reader comments according to which tier and thread each comment belongs to.

This application claims the benefit of U.S. Provisional Application No. 61/232,306, filed Aug. 7, 2009, which is hereby incorporated by reference.

### BACKGROUND

Extremely popular websites such as gawker.com and io9.com have a staff of writers and editors that generate original content on a daily basis. These websites report on such things as celebrity gossip, electronic gadgets, video games, science fiction, and the like. Millions of people read these websites each day and many of those readers have strong opinions about the articles they read and other related subject matter.

To engage readers more thoroughly—and keep them from navigating away from the website—many sites implement a commenting system whereby a reader may leave a written comment that is displayed under the story they are commenting on. Other readers may comment in response to previous comments, or they may start their own commenting thread.

While such commenting systems may be empowering to readers, it often results in a flood of comments, most of which are not interesting or of low quality, inappropriate or off-subject, or do not add to the content of the story in any intelligent way.

To avoid this, some websites employ full-time comment moderators who review each comment and approve only those comments they feel are aligned with the ethos of the site. Such moderators, however, are limited in the number of comments they can review and they may not be able to review and approve all interesting comments in a timely manner. Furthermore, a comment moderator could have a bias against specific commenters or certain types of comments and may not publish comments that other readers might find interesting.

Other website implement user or comment ranking methods whereby a reader can set a comment threshold and display only those comments that exceed the threshold. Unfortunately, methods such as these are overly complicated and require readers to rank comments in a poorly controlled or ambiguous manner. Furthermore, for the method to work, readers must set an arbitrary comment threshold in order to limit the number of comments that are displayed. Even worse, because readers can set their own thresholds, the website loses much of the comment quality control gained through the use of full-time comment moderators.

Thus, a need presently exists for a commenting method and system that automatically displays the most relevant, interesting, or appropriately controversial comments without the expense, bias, and latency caused by a full-time human moderator.

### SUMMARY

A commenting method publishes comments on an internet connected electronic device. A first comment is received from a first commenter, wherein the first comment is received by way of an electronic device connected to a telecommunications network. If the first commenter is not registered, the first comment is automatically registered. If the first commenter is not a starred commenter, the first comment is flagged. Specifically, if the first commenter is unapproved, then the first comment is published to only starred commenters, and the first comment is flagged as a tier 2 commenter only if approved by a starred commenter. If the first commenter is approved, the first comment is flagged as a tier 2 comment. If a tier 2 comment is approved by a starred commenter, the tier 2 comment is flagged as a tier 1 comment. If, however, the first commenter is a starred commenter, the first commenter is flagged as a tier 1 comment. All tier 1 comments are electronically published such that they are displayed on an electronic device connected to the telecommunications network. If the tier 1 comment is in reply to another commenter, the antecedents of the first comment are also published.

### BRIEF DESCRIPTION OF THE DRAWINGS

FIG. 1 shows an exemplary webpage comprising an article with comments.

FIG. 2 is a commenting method.

FIG. 3 is a method for verifying comments from unregistered commenters.

FIG. 4 is a commenting system.

FIG. 5A shows an exemplary screenshot of a starred commenter replying to a tier 2 comment.

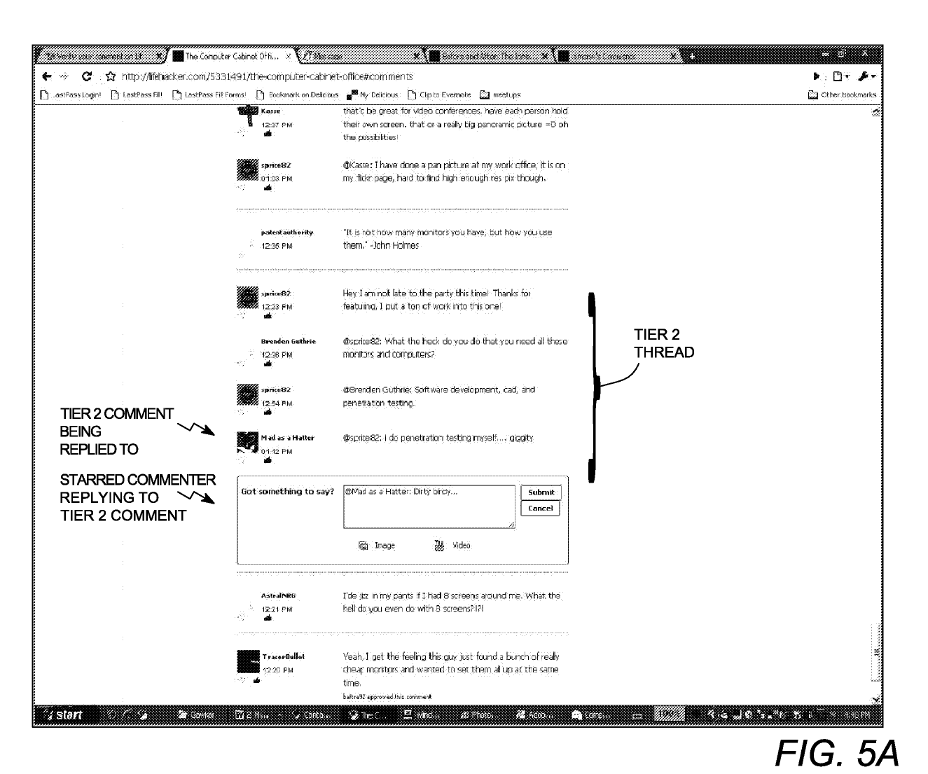

FIG. 5B shows an exemplary screenshot of a submitted starred comment and the antecedents to the starred comment upgraded from tier 2 to tier 1 comments.

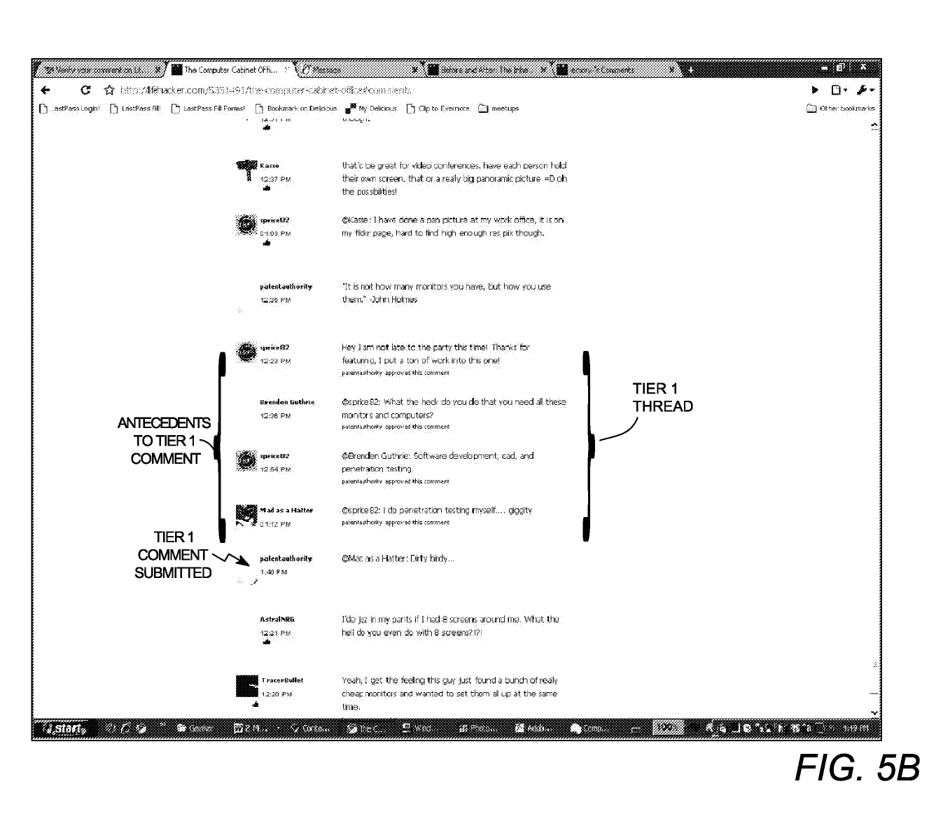

FIG. 5C shows an exemplary screenshot of only tier 1 comments.

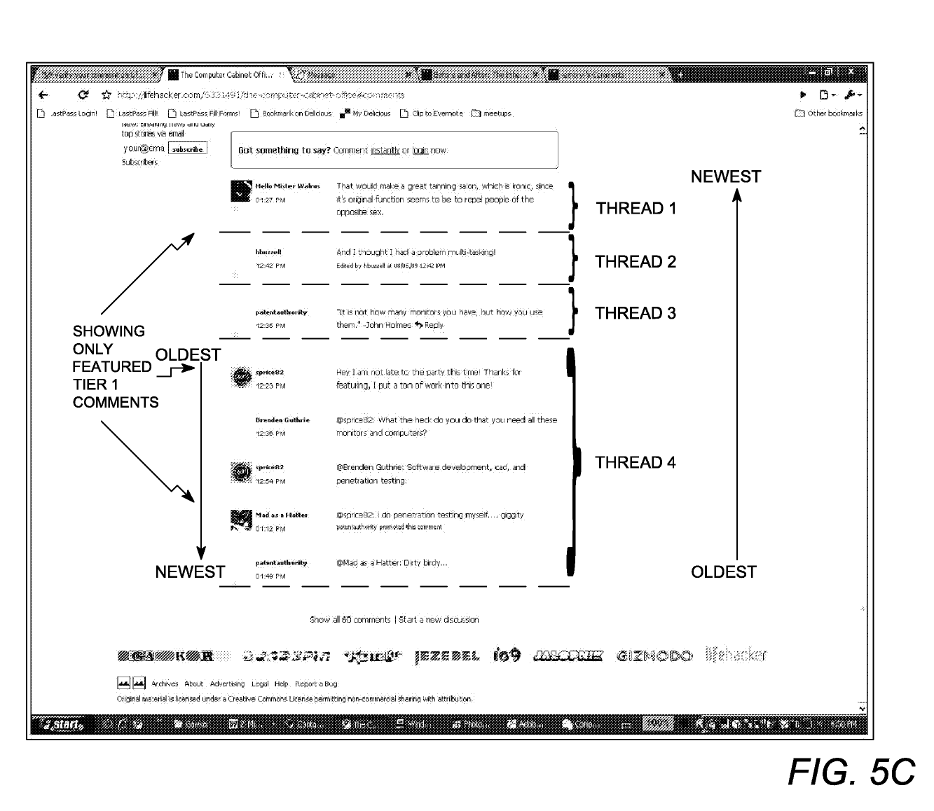

FIG. 6A shows an exemplary screenshot of an unregistered commenter submitting a comment.

FIG. 6B shows the unregistered comment just after submission.

FIG. 6C shows an exemplary electronic verification message sent to an unregistered commenter in accordance with FIG. 3.

FIG. 6D shows an exemplary confirmation that the comment was verified in accordance with FIG. 3.

FIG. 7A shows an exemplary screenshot of an unregistered comment being submitted.

FIG. 7B show an exemplary screenshot of the comments displayed to only starred commenters, including the unregistered comment of FIG. 6A.

FIG. 8 shows an exemplary screenshot of comments received from an external feed displayed under an article as shown in FIG. 1.

### DETAILED DESCRIPTION

### Definitions

“Starred commenter”—A tier 1 commenter, moderator, or editor.

“Tier 1 commenter”—A starred commenter. A starred commenter has some comment moderation privileges. Specifically, a starred commenter or tier 1 commenter can:
1) Promote a well-written, thought out, intelligent, or otherwise notable comment in tier 2 to tier 1 in order to give it a higher profile. In addition, when a starred commenter in tier 1 responds to a commenter in tier 2, the tier 2 comment is moved to tier 1.
2) View unapproved comments from new commenters and approve them so that they appear on the site in tier 1. Approving an unapproved comment does not mean the commenter is approved; the approval is for one-time only and does not give the commenter full commenter privileges.

“Tier 2 commenter”—A registered commenter who can submit comments and reply to others' comments but cannot promote any comment to tier 1. A comment submitted by a tier 2 commenter remains a tier 2 comment unless replied to or promoted by a tier 1 commenter or higher. A tier 2 commenter remains a tier 2 commenter even if his comment is upgraded to tier 1; a commenter is not upgraded in status because his comment is. Additionally, a tier 2 commenter may be an “unapproved registered commenter,” or an “approved registered commenter.” If the commenter is unapproved and registered then a comment from the commenter must be approved by a starred commenter in order to be displayed as a tier 2 comment. If the commenter is approved and registered then the comment will be published as a tier 2 comment automatically.

“Registered commenter”—A tier 1 or tier 2 commenter.

“Unregistered commenter”—A commenter who is not a tier 1 or tier 2 commenter. An unregistered commenter may be anonymous. A comment submitted by an unregistered commenter is only displayed to tier 1 commenters. If a tier 1 commenter approves the comment, the comment becomes a tier 2 comment. If the comment is replied to or promoted by a tier 1 commenter, the comment becomes a tier 1 comment.

“Moderator”—A starred commenter that can promote a tier 2 commenter to tier 1. A moderator has all of the privileges of a tier 1 commenter and more. A moderator may remove a comment, demote a tier 1 commenter to a tier 2 commenter, ban a commenter, promote a tier 2 commenter to tier 1, invite someone to become a registered commenter, register a commenter, and approve a commenter. A moderator's actions supersede those of a tier 1 commenter. A tier 1 commenter may be made a moderator by an editor.

“Editor”—A supervisor of the website. An editor's actions supersede those of a moderator. An editor selects the moderators.

“Tier 1 comment”—A comment that is always displayed to everyone, by default, when the article is viewed. In one example, tier 1 comments are displayed directly under an article. A tier 1 comment can be provided by a tier 1 commenter, a tier 2 commenter, or an unregistered commenter. All comments provided by a tier 1 commenter are tier 1 comments. A comment replied to or promoted by a tier 1 commenter becomes a tier 1 comment as does that comment's antecedents.

“Tier 2 comment”—A comment that is visible to everyone upon clicking a link to “display all comments.” A tier 2 comment becomes a tier 1 comment if it is replied to or promoted by a tier 1 commenter, or if any of the comment's descendents are replied to or promoted by a tier 1 commenter.

“Unapproved comment”—A comment that is only visible to tier 1 commenters. The comment remains invisible to all but tier 1 commenters until a tier 1 commenter approves the comment. When approved by a tier 1 commenter, the unapproved comment advances to a tier 2 comment.

“Antecedent comment”—Any comment in a chain of replies that precedes the present comment. In the example below, Comments 1 and 2 are antecedents to Comment 3.
Comment 1 (New thread comment)
   ↓
Comment 2 (reply to comment 1)
   ↓
Comment 3 (reply to comment 2)
   ↓
Comment 4 (reply to comment 3)
   ↓
Comment 5 (reply to comment 4)

“Descendent comment”—Any comment in a chain of replies to the present comment. In the example above, Comments 4 and 5 are descendents to Comment 3.

“New thread” or “Thread starter”—A comment that is not a reply to another comment. For example, Comment 1 above is a new thread comment.

“Thread”—A chain of comments all related to each other. For example, Comments 1-5 above are part of a single thread. A thread is created when a commenter replies to another comment. Subsequent replies to the last comment in the thread adds to the thread. If a reply is made in the middle of a thread, the thread may be split.

“Article”—An article may comprise a post such as a blog posting, a multiplicity of posts, a tag, a hashtag such as the results of a TWITTER search, a keyword search of any online resource, a comment, text, audio, video, images, computer executable code, and the like.

“Comment”—A comment is a response to an article and may comprise text, links, audio, video, images, computer executable code, and the like.

Commenting Method and System

A two tier commenting method and system provides greater control of comments, and automatically present the best comments to readers of a website. For example, it may be desirable to present the funniest, thoughtful, intelligent, or best-argued comments, and not display comments that are uninformative, unsubstantial, off-point, inappropriately hostile, and the like.

Comment threads are broken up into two sections hereinafter referred to as tiers. Tier 1 comments are always displayed, appear directly below each article, and comprise the comments of starred commenters. Tier 2 comments comprise the contributions of everyone else, that is, those without stars. To view tier 2, a user clicks on a directive (such as a link or button) “Show all comments on this post” or equivalent. Upon clicking, all comments in tier 1 and tier 2 are shown together.

Stars are granted or taken away by moderators or higher. Starred commenters function as mini-moderators. A starred commenter can:
1) Promote a tier 2 comment to tier 1 thereby giving it a higher profile. In addition, when a starred commenter in tier 1 responds to a commenter in tier 2, the tier 2 comment is moved to tier 1.
2) View unapproved comments from new commenters and approve them so that they appear on the website in tier 1. Approving an unapproved comment does not mean the commenter is approved; the approval is for one-time only and does not give the commenter full commenter privileges.

Commenter moderators can override a tier 1-promoted comment and demote it to tier 2. In addition, a starred commenter can lose their star for a variety a reasons, for example if they abuse other commenters, break commenting rules, or approve, promote, or respond to tier 2 commenters in order to start or highlight unnecessary arguments.

Commenters can edit their comments after publication. For a set period of time, for example 15 minutes, following the publishing of a comment, the commenter may click on a small “pencil” tool icon that is displayed underneath each comment. By doing so, the commenter can modify the comment in order to fix mistakes in spelling, coding, grammar, and the like.

Commenters may upload images, audio, video, computer executable code, and the like to be included as part of their comment.

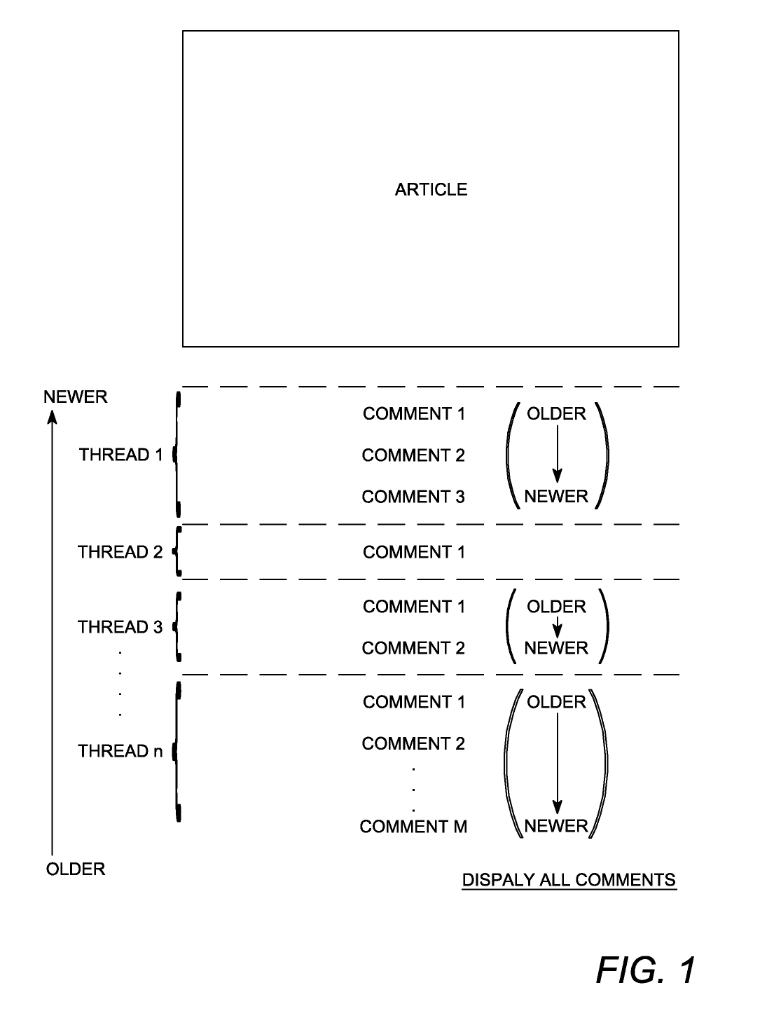

FIG. 1 shows an exemplary webpage comprising an article with comments. Threads are displayed in reverse chronological order, newest on top to oldest on bottom. Within comment threads, replies are displayed in chronological order.

By default, all tier 1 comments are displayed. In this way, only the most interesting and relevant comments are displayed to all viewers of the webpage. A viewer may alternatively view all tier 1 and tier 2 comments at the same time by clicking the link “Display All Comment” or equivalent displayed at the bottom of the webpage. Upon doing so, all tier 1 and 2 comments are displayed in reverse chronological order for the threads and in chronological order within each thread.

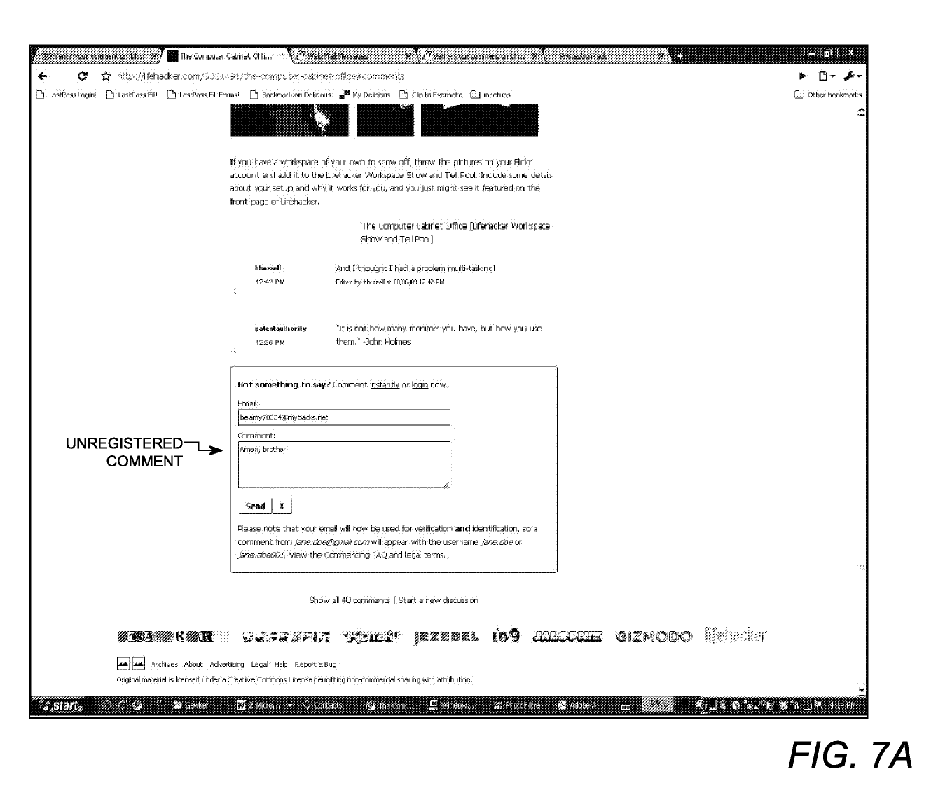

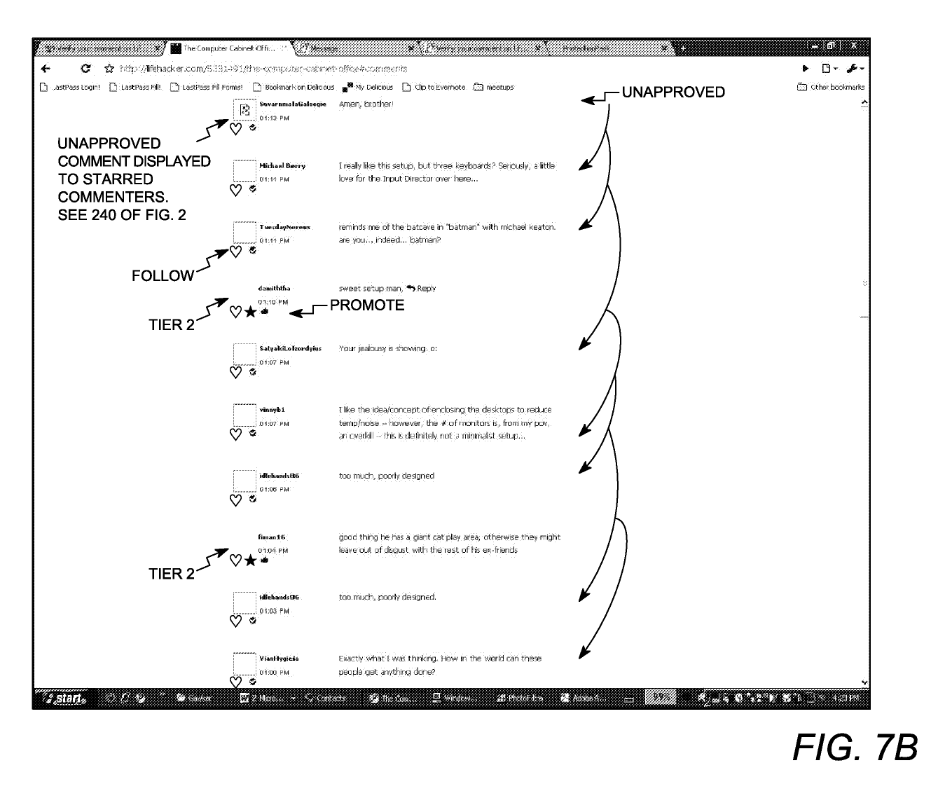

Any tier 1 commenter can view all tier 1, tier 2, and unapproved comments by logging into the site and displaying all comments (see FIG. 7B). Comments are displayed as threads in reverse chronological order, newest on top to oldest on bottom. And, within comment threads, replies are displayed in chronological order. Tier 1, tier 2, and unapproved comments are distinguished from each other by way of shading, highlighting, font size, font type, font weight, and the like.

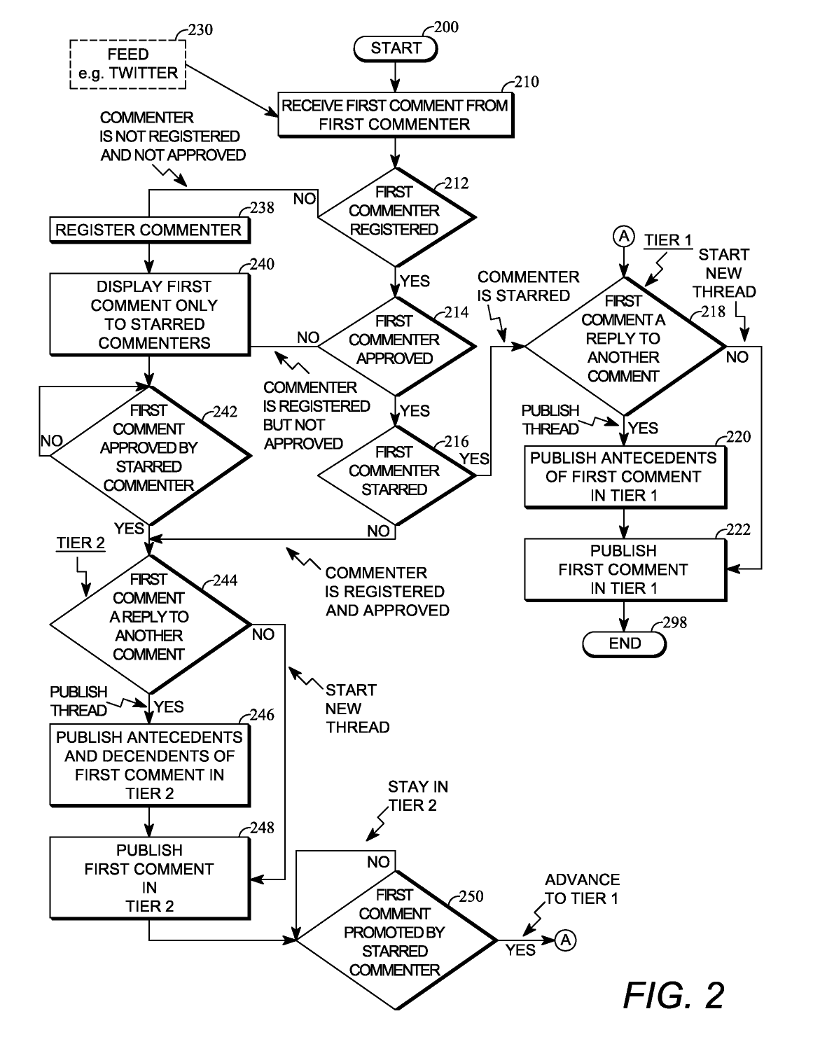

With the above disclosure in mind, FIG. 2 shows a commenting method. At step 210, a first comment is received. The first comment is associated with a first commenter. The comment is in response to an article. For example, the comment may be in response to a blog posting. In another example, the comment is in response to another comment. In yet another example, the comment is in response to an image. In still another example, the comment is in response to a comment received from a website such as TWITTER.

No matter the type of article, if at step 212 the first commenter is determined to be unregistered, then the first comment is displayed only to starred commenters 240; the commenter is neither registered nor approved.

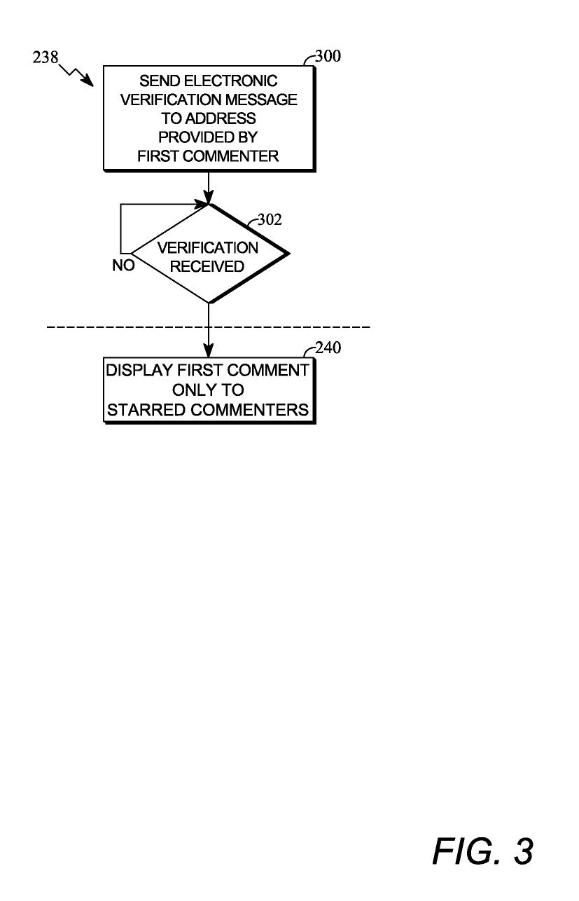

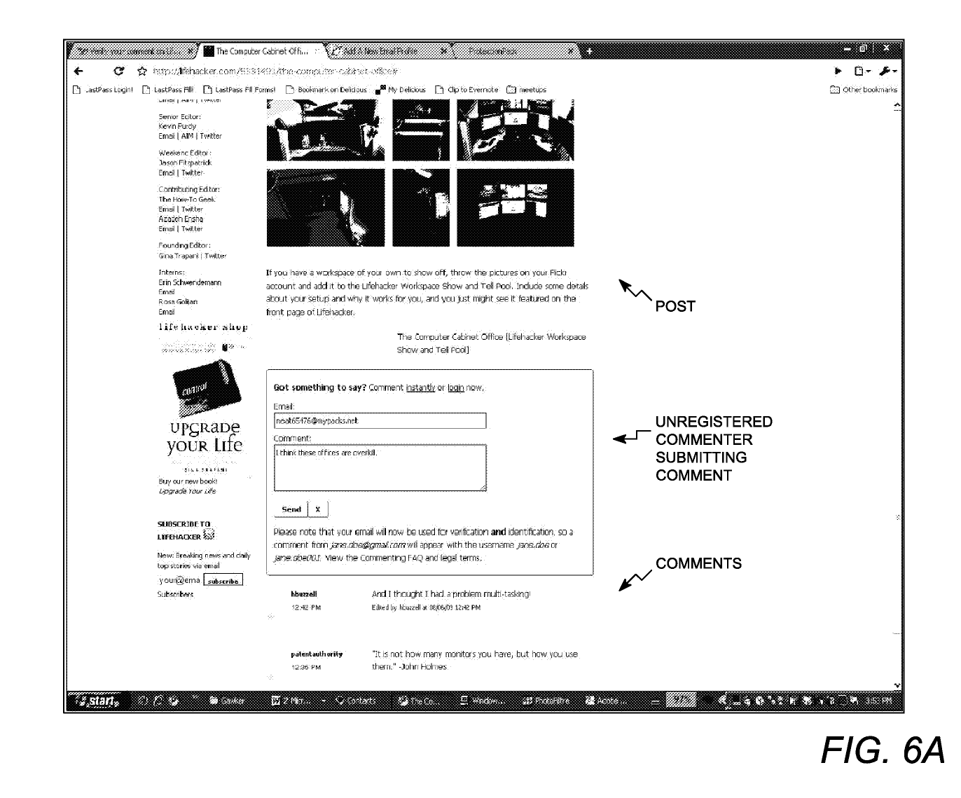

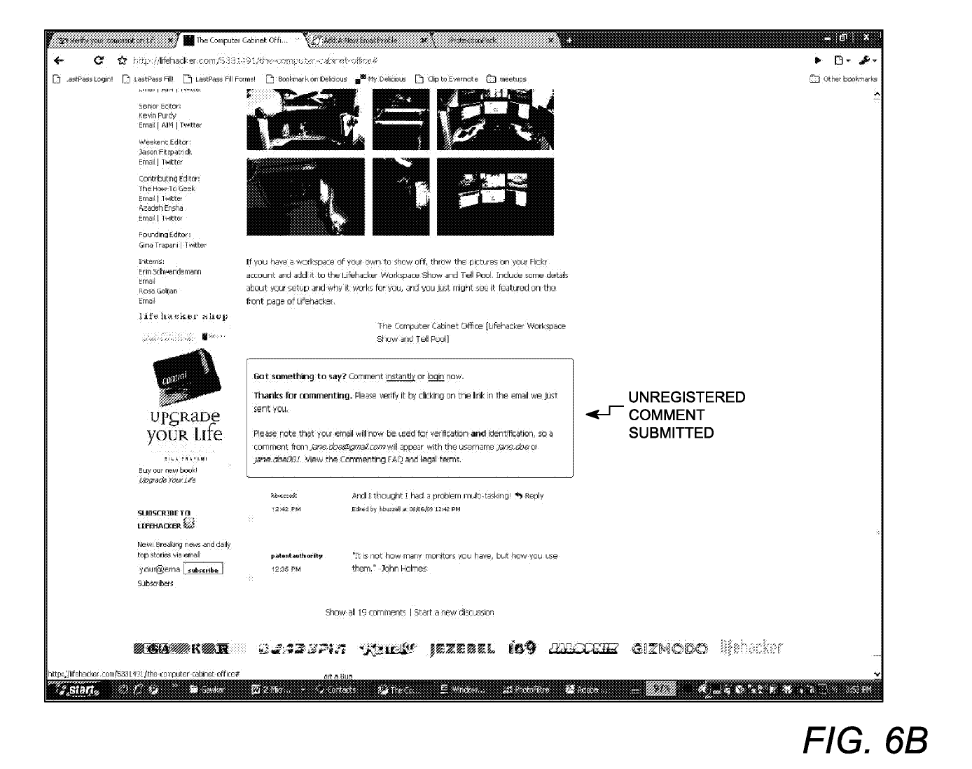

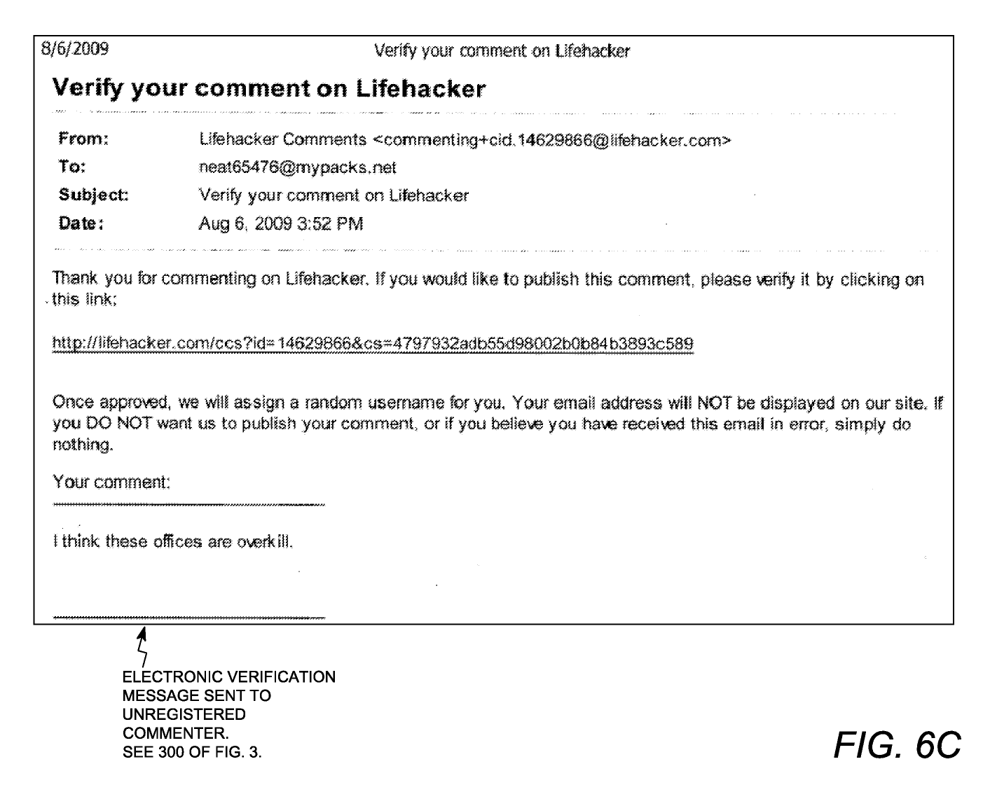

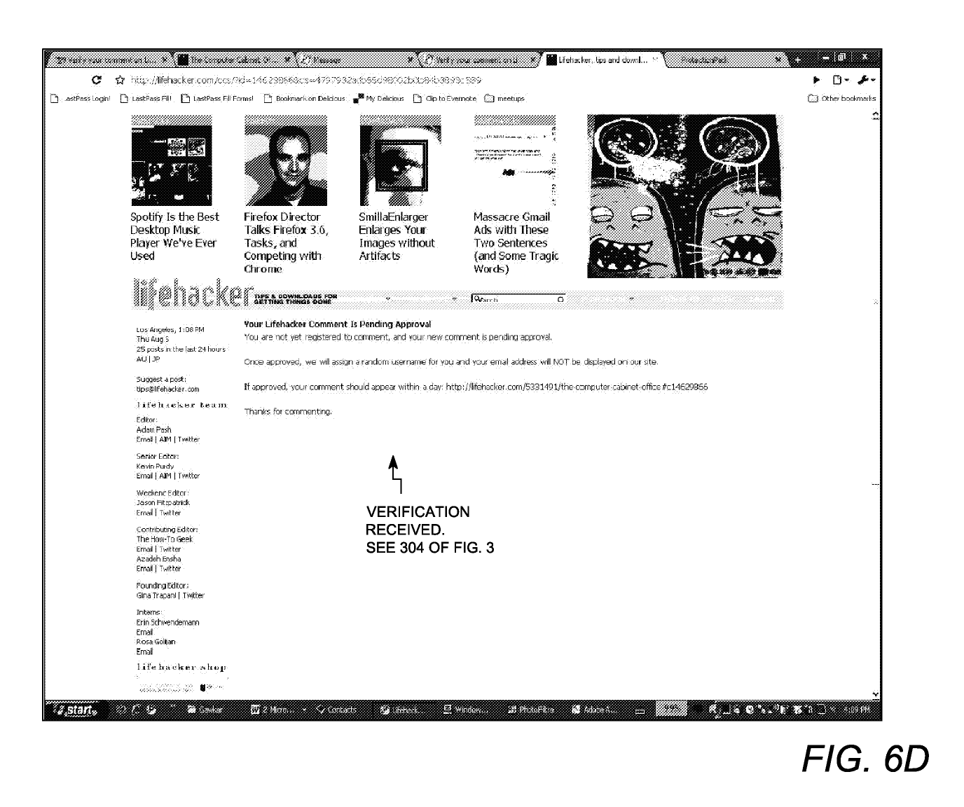

At step 238 the first commenter is automatically registered. In registering 238, a username, anonymous or otherwise, is assigned to the first commenter and associated with the email address provided by the first commenter. For example, referring to FIGS. 6A-D, the unregistered commenter verifies his comment before it is displayed to starred commenters (step 240 of FIG. 2, and FIG. 3). However, after automatic registration 238, if the same commenter submits a second comment, the second comment is displayed to starred commenters 240, and the verification steps (300 and 302 of FIG. 3) are skipped. Furthermore, if after automatic registration the first commenter is approved or awarded a star by a moderator or editor, the second comment is automatically published in tier 2 (“yes” branch of 214 and “no” branch of 216) or tier 1 (“yes” branch of 214 and “yes” branch of 216) in accordance with the steps of FIG. 2.

If at step 212 the first commenter is determined to be registered, then at step 214 it is determined if the first commenter is an approved commenter. If the commenter is not approved, that is the commenter is registered but not approved, then at step 240 the first comment is displayed only to starred commenters and comment verification is skipped.

At step 242, the first comment remains invisible to all commenters except starred commenters (“no” branch) until it is approved by a starred commenter (“yes” branch). If approved, at step 244, if the first comment is not a reply to another comment then the comment is a thread starter and the first comment is published at step 248 as a tier 2 comment. If the first comment is a reply to another comment then at step 246 the antecedents and descendents of the first comment are published with the first comment at step 248.

Returning to step 214, if the first commenter is an approved commenter (“yes” branch) then at step 216 it is determined if the first commenter is a starred commenter. If the commenter is not a starred commenter but the commenter is a registered and approved commenter, the first comment is a tier 2 comment, and the first comment is published in accordance with steps 244, 246, and 248.

If the commenter is a starred commenter (“yes” branch of step 216) then the commenter is a starred commenter and the first comment is a tier 1 comment. At step 218, if the first comment is not in reply to another comment then the first comment is a thread starter and published 222 in tier 1. If the first comment is in reply to another comment then the antecedents of the first comment are published 220 in tier 1 along with the first comment in step 222. Note, the antecedents are published at step 220 even if those antecedents are tier 2 comments. In this way, the tier 2 comments are automatically promoted to tier 1 comments and are displayed by default along with the article.

Tier 2 comments published at steps 246 and 248 remain in tier 2 unless promoted by a starred commenter (step 250). At step 250 the tier 2 comment is promoted to a tier 1 comment in accordance with tier 1 steps 218, 220, and 222.

In publishing comments as disclosed above, it is appreciated that the publication steps of FIG. 2, and in fact all of the steps, may be carried out in any order, in serial or in parallel, and in part or in whole. For example, the step of publishing the antecedents 220 is shown prior to publishing the first comment 222 merely for illustrative purposes and it is understood that, in practice, the antecedents may be published with an article prior to or in conjunction with receiving a comment.

The first comment of step 210 is received via a webform, a text input box, or equivalent such as shown in FIG. 6A. The first comment may also be received via other mean such as email, instant messenger, text message, a feed (230 of FIG. 2), and the like.

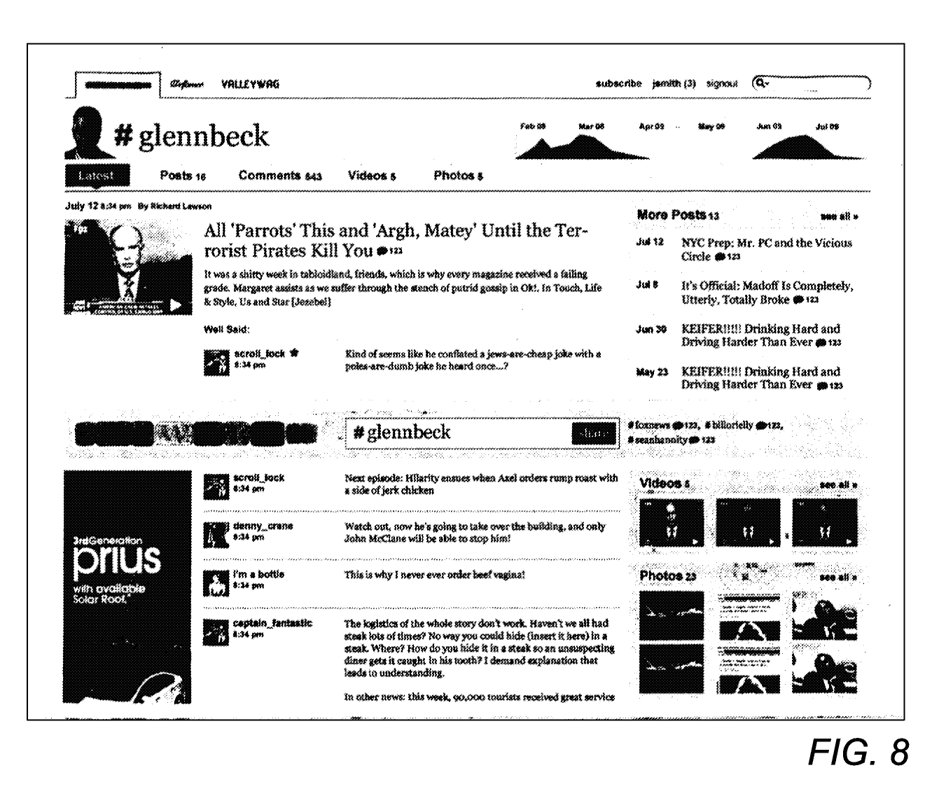

FIG. 8 shows an exemplary screenshot with comments received from an external feed. With reference to FIG. 2, a feed such as a TWITTER feed, or any XML formatted file or equivalent, is provided at step 230. The feed is parsed to extract each comment and commenter in the feed, and each of those comments is received at step 210 and processed according to the steps of FIG. 2.

Parsing XML feeds is well understood by those having ordinary skill in the art. In the example shown in FIG. 8, the article is for the hashtag #glennbeck. Also, as shown in FIG. 8, it is noted that since each comment may have one or more associated hashtags, a dynamic and timely webpage may be generated for all related comments, no matter the source, on nearly any subject. In this way, the comments themselves become the news, story, or the focal point of the story, and the original article, or more than one article, serves as a seed to grow fascinating, current, provocative, and updated news and opinion. Furthermore, web pages can include multiple “articles” or “forums” of such user generated news and opinion on many different subjects defined by hashtags or equivalent. The articles can be displayed, for example, in order of most recent comments or greatest number of comments. It is appreciated that many other metrics may be used, alone and in combination, to determine and arrange the order of display.

Recall, any commenter that is not registered may be automatically registered at step 238. It is appreciated that automatic registration may include automatically registering a user of TWITTER, FACEBOOK, or any other social networking site, whereby the username described in accordance with step 238 is equivalently, for example, the user's TWITTER username. And, the email address described in accordance with step 238 is, for example, an electronic identifier indicating that the username refers to a TWITTER user and his public TWITTER feed. That is, in this example, users may be messaged, via TWITTER instead of by way of traditional email, and comments may be received by way of a TWITTER feed or some other feed.

So, a verification message may be sent to any electronic identifier. It is also appreciated that while verification has been described with automatic registration 238, automatic registration 238 may be carried out without the steps of verification 300, 302, in which case a username is automatically assigned to a commenter and a comment displayed without verification of the user. It is also appreciated that automatic registration may be carried out with modified verification steps 300, 302 wherein an electronic verification message is transmitted to someone other than the commenter, such as a moderator.

Thus, it is possible that a user of a site such as TWITTER becomes a registered commenter even though they may have never used or be aware of a website using the method of FIG. 2. And, if promoted by a moderator or higher, that registered commenter can become a registered and approved commenter, or a starred commenter. So, in this example, a prolific user on TWITTER may become a featured commenter on a different site practicing the method of FIG. 2 without the TWITTER user being aware of it.

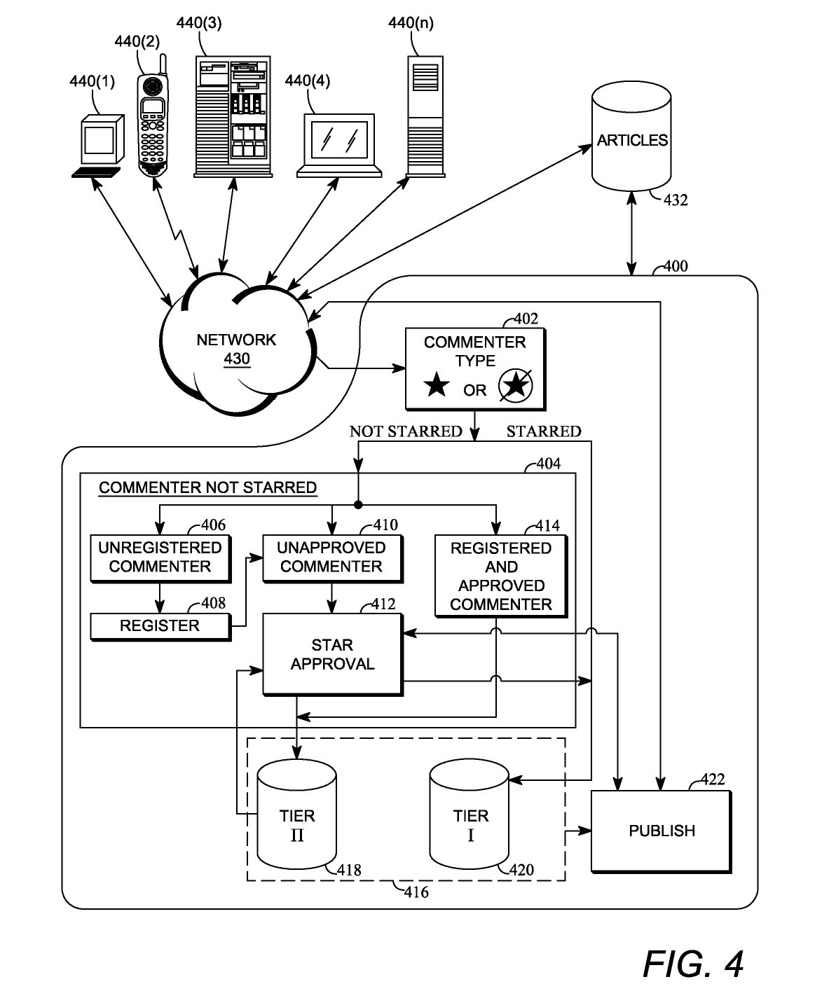

With the above disclosure in mind, FIG. 4 shows a commenting system 400 and a multiplicity of electronic devices 440(1)-440(n) all in communication with a communication network 430. Also, in communication with the network 430 and system 400 is an articles database 432 for storing article.

Comments are received by the commenting system 400 by way of the communication network 430 from one or more electronic device 440. And, comments are published by the commenting system 400 by way of the communication network 430 to one or more electronic device 440.

The electronic devices 440 may include, without limitation, computers 440(1), mobile devices 440(2) such as iPhones, Personal Digital Assistants (PDAs), mobile phones, tablets, and the like, servers 440(3) such as social networking servers such as TWITTER, and laptop computers 440(4).

The communication network 430 comprises, one or more of the Internet, a Local Area Network (LAN), a Wide Area Network (WAN), or any other network capable of communicating digital data. The computer network 102 may be wired, wireless, or a combination of wired and wireless.

Briefly, the commenting system 400 comprises a commenter-type module 402 in communication with a commenter-not-starred module 404 and a database 416. Database 416 comprises a tier 1 database 420 and a tier 2 database 418. The commenter-not-starred module 404 is in communication with a publishing module 422 and database 416. The database 416 is in communication the publishing module 422.

The commenter-not-starred module 404 comprises an unregistered-commenter module 406, an unapproved-commenter module 410, and a registered-and-approved-commenter module 414 all in communication with the commenter-type module 402. Furthermore, the commenter-not-starred module 404 comprises a register module 408 in communication with the unregistered-commenter module 406 and unapproved-commenter module 410. Also included in module 404 is the star-approval module which is in communication with the database 416 (which includes the tier 1 database 420 and the tier 2 database 416) and the publishing module 422.

The commenter-type module 402 determines if the commenter associated with the received comment is a starred or not-starred commenter. As already disclosed, the comment is associated with a commenter by way of an electronic identifier which may include, for example, email addresses, mobile phone numbers, user IDs for instant messaging services, user IDs for social networking application, user IDs and URLs for blogs and micro-blogs, URIs, and the like.

The commenter-type module 402 is in communication with the tier 1 database 420 of database 416. The database 416 is in communication with the publishing module 422 which is in communication with the network.

The database 416 may be any conventional database such as an Oracle database or SQL database. The database includes the tier 2 database 416 and the tier 1 database 420. It is understood, however, that the database may be a single physical database and that the logical distinction between a tier 1 comment and a tier 2 comment may be made by way of fields, or “flags,” in each element of the database. For example, each element in the database may be defined as having the following fields:

(comment, tier_{—}1, tier_{—}2, date, time, articleID, commenterUN, commenterID, starred, registered, approved)

wherein,

comment=the comment;

tier_{—}1=1 if the comment is a tier 1 comment, 0 if not a tier 1 comment;

tier_{—}2=1 if the comment is a tier 2 comment, 0 if not a tier 2 comment;

date=the date of the comment;

time=the time of the comment;

articleID=a pointer to the article to with the comment was made;

commenterUN=the username of the commuter;

commenterID=the electronic identifier of the commenter;

starred=1 if the commenter is starred, 0 if the commenter is not starred;

registered=1 if the commenter is registered, 0 if not registered;

approved=1 if the commenter is approved, 0 if not approved.

It is understood that this is only one exemplary definition of a database element and that other elements and fields are possible.

A comment in the database can be made a tier 1 comment or a tier 2 comment by setting the bits of flags tier_{—}1 and tier_{—}2 accordingly. Hereinafter, the term “flagging” means storing a comment in a database and storing data in a field of the database identifying the comment as a tier 1 comment, tier 2 comment, unapproved comment, and the like. For example, a tier 2 comment (tier_{—}1=0, tier_{—}2=1) may be flagged as a tier 1 comment by setting tier_{—}1=1 and tier_{—}2=0. A database such as this and the operations of flagging are well understood by those having ordinary skill in the art. The step of flagging is carried out by one or more of the modules of the system 400, for example star-approval module 412.

The publishing module 422 reads comments from the database 416 and publishes them. Publishing comprises generating and transmitting computer executable code to an electronic device 440 such that when executed by a processor of the electronic device causes the electronic device to display the comments. Examples of code include XML, HTML, JAVA, FLASH, and any code that is executable within a web browser or causes a web browser to display information.

The publishing module 422, by default, publishes tier 1 comments 420. The publishing module, which is also in communication with the star-approval module 412 also publishes tier 2 and unapproved comments as necessary. For example, see steps 240, 242, 244, 246, and 248 of FIG. 2.

The commenter-type module 402 is also in communication with a commenter-not-starred module 404 which performs the steps disclosed above associated with checking if a commenter is registered and approved, registering a commenter, and checking if comments have approved by a starred commenter.

The commenter-not-starred module 404 comprises an unregistered-commenter module 406, an unapproved-commenter module 410, and a registered-and-approved-commenter module 414 all in communication with the commenter-type module 402. Furthermore, the commenter-not-starred module 404 comprises a register module 408 in communication with the unregistered-commenter module 406 and unapproved-commenter module 410. Also included in module 404 is the star-approval module which is in communication with the database 416 (tier 1 database 420 and tier 2 database 416) and the publishing module 422.

Finally, the disclosed methods and systems, and any modification thereof may be implemented on any computer using any array of widely available and well understood software platforms, operating systems, programs, and programming languages. For example, the systems and methods may be implemented on an Intel or Intel compatible based computer running a version of the Linux operating system or running a version of Microsoft Windows. The computer may include any and all components of a computer such as storage like memory and magnetic storage, interfaces like network interfaces, and microprocessors.

A computer program product may include a computer readable medium comprising computer readable code which when executed on the computer causes the computer to perform the methods described herein. The components of the computer, including creating, storing, modifying, and querying databases, and interfacing and communicating with networks and electronic devices connected to the network are well understood by those having ordinary skill in the art.

The foregoing description has discussed only a few of the many forms that this invention can take. It is intended that the foregoing detailed description be understood as an illustration of selected forms that the invention can take and not as a definition of the invention. It is only in the claims, including all equivalents, that are intended to define the scope of this invention.

What is claimed is:

1. A commenting method for publishing comments on an internet connected electronic device, the method comprising:
(a) receiving a first comment from a first commenter, wherein the first comment is received by way of an electronic device connected to a telecommunications network;
(b) if the first commenter is not registered, registering the first commenter;
(c) if the first commenter is not a starred commenter, flagging the first comment, wherein the step of flagging comprises,
(i) if the first commenter is unapproved, publishing the first comment to only starred commenters; and flagging the first comment as a tier 2 comment only if approved by a starred commenter;
(ii) if the first commenter is approved, flagging the first comment as a tier 2 comment;
(iii) if the tier 2 comment is approved by a starred commenter, flagging the first comment as a tier 1 comment;
(e) if the first commenter is a starred commenter, flagging the first comment as a tier 1 comment; and
(f) publishing the tier 1 comment such that it is displayed on an electronic device connected to the telecommunications network.

2. The method of claim 1 further comprising, if the tier 1 comment published in (f) is in reply to another comment, publishing the antecedents of the first comment.

3. The method of claim 2 wherein the step of publishing the antecedents of the first comment comprises:
reading the antecedent comments from a tier 1 database and a tier 2 database; and
transmitting computer executable code to an electronic device such that when executed by a processor of the electronic device causes the electronic device to display the antecedent comments.

4. The method of claim 1 further comprising:
receiving a request from an internet connected electronic device to display tier 2 comments;
publishing the tier 2 comment on the internet connected electronic device; and
if the tier 2 comment is in reply to another comment, publishing the antecedents and descendents of the tier 2 comment;

5. The method of claim 4 wherein the step of publishing the antecedents and descendents comprises:
reading the antecedent and descendent comments from a tier 2 database; and
transmitting computer executable code to an electronic device such that when executed by a processor of the electronic device causes the electronic device to display the antecedent and descendent comments.

6. The method of claim 1 wherein the publishing in (f) comprises generating computer executable code, and transmitting the computer executable code to an electronic device such that when executed by a processor of the electronic device causes the electronic device to display the tier 1 comment.

7. The method of claim 1 wherein the receiving in (a) comprises receiving the first comment from a feed.

8. The method of claim 1 wherein the step of registering comprises verifying the first commenter.

9. The method of claim 1 wherein the step of registering comprises receiving an electronic identifier identifying the first commenter.

10. The method of claim 1 where the step of flagging further comprises storing the first comment in a database and storing data in a field of the database identifying the first comment as a tier 1 comment, a tier 2 comment, or an unapproved comment.

11. The method of claim 1 further comprising publishing the first comment on an electronic device of a starred commenter.

12. The method of claim 1 further comprising publishing an article related to the first comment.

13. The method of claim 1 wherein the first comment comprises at least one of text, an image, audio, video, and computer executable code.

14. A commenting system in communication with a network and a plurality of electronic devices, the commenting system comprising:
a database comprising a tier 1 database and a tier 2 database;
a publishing module in communication with the network and the database;
a commenter-type module in communication with the network and the tier 1 database; and
a commenter-not-starred module in communication with the commenter-type module, the tier 1 database, the tier 2 database, and the publishing module.

15. The system of claim 14 wherein the commenter-not-starred module comprises,
an unregistered-commenter module in communication with the commenter-type module;
an unapproved-commenter module in communication with the commenter-type module;
a registered-and-approved-commenter module in communication with the commenter-type module and the tier 2 database;
a register module in communication with the unregistered-commenter module and the unapproved-commenter module; and
a star-approval module in communication with the unapproved-commenter module, the tier 1 database, the tier 2 database, and the publishing module.

16. The system of claim 14 further comprising an articles database in communication with the publishing module.

17. A computer program product comprising a computer readable medium including a computer readable program, wherein the computer readable program when executed by a microprocessor of a computer causes the computer to perform the step of:
(a) receiving a first comment from a first commenter, wherein the first comment is received by way of an electronic device connected to a telecommunications network;
(b) if the first commenter is not registered, registering the first commenter;
(c) if the first commenter is not a starred commenter, flagging the first comment, wherein the step of flagging comprises,
(i) if the first commenter is unapproved, publishing the first comment to only starred commenters; and flagging the first comment as a tier 2 comment only if approved by a starred commenter;
(ii) if the first commenter is approved, flagging the first comment as a tier 2 comment;
(iii) if the tier 2 comment is approved by a starred commenter, flagging the first comment as a tier 1 comment;
(e) if the first commenter is a starred commenter, flagging the first comment as a tier 1 comment; and
(f) publishing the tier 1 comment such that it is displayed on an electronic device connected to the telecommunications network.

18. A commenting system comprising:
mean for receiving a first comment from a first commenter, wherein the first comment is received by way of an electronic device connected to a telecommunications network;
means for determining if the first commenter is registered and approved;
means for registering the first commenter if the if the first commenter is not registered
means for flagging the first comment responsive if the first commenter is not a starred commenter, wherein the means for flagging comprises,
if the first commenter is unapproved, means for publishing the first comment to only starred commenters; and means for flagging the first comment as a tier 2 comment only if approved by a starred commenter;
if the first commenter is approved, means for flagging the first comment as a tier 2 comment;
if the tier 2 comment is approved by a starred commenter, means flagging the first comment as a tier 1 comment;
means for flagging the first comment as a tier 1 comment if the first commenter is a starred commenter; and
means for publishing the tier 1 comment such that it is displayed on an electronic device connected to the telecommunications network.
